(19) United States
(12) Patent Application Publication
(10) Pub. No.: US 2008/0104889 A1
(43) Pub. Date: May 8, 2008

(54) Rail assembly for slide-type garage door

(76) Inventor: Chung-Min Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/592,992

(22) Filed: Nov. 6, 2006

(51) Int. Cl. E05F 15/00

(52) U.S. Cl. 49/199

(57) ABSTRACT

A rail assembly for slide-type garage door includes multiple rails linearly connected to one another. Each rail has a horizontal portion adapted to allow a slide smoothly move thereon, and a vertical portion centrally and perpendicularly extending from the horizontal portion to form an inverted T-shape. Multiple connectors partially receive the vertical portion of the multiple rails. Each connector has a slot defined therein for receiving the vertical portions of two linearly connected rails. Each connector has a first side wall and a second side wall parallel with each other and integrally connected to each other for defining the slot. Multiple bolts respectively and sequentially extend through the first side wall of the connector and the vertical portion of the rail, and are screwed into the second side wall to stably fasten the multiple rails and the multiple connectors.

### BACKGROUND OF THE INVENTION

1. Field of the Invention

The present invention relates to a rail assembly, and more particularly to a rail assembly for slide-type garage door.

2. Description of Related Art

A conventional rail structure for slide-type garage door in accordance with the prior art shown in FIG. 8 comprises an integral rail (40) to allow a slide (50) smoothly move thereon. A length of a car usually about two meters such that the conventional integral rail (40) must be over two meters. Such a long structure is heavy and inconvenient for operating and transport. In addition, the manufacturer needs to prepare multiple rails with different lengths. As a result, manufacturing processes are complicated.

The present invention has arisen to mitigate and/or obviate the disadvantages of the conventional rail structure for slide-type garage door.

### SUMMARY OF THE INVENTION

The main objective of the present invention is to provide an improved rail structure for slide-type garage door, which is easily assembled and transported.

To achieve the objective, the rail assembly in accordance with the present invention comprises multiple rails linearly connected to one another. Each rail has a horizontal portion adapted to allow a slide smoothly move thereon, and a vertical portion centrally and perpendicularly extending from the horizontal portion to form an inverted T-shape. Multiple connectors partially receive the vertical portion of the multiple rails. Each connector has a slot defined therein for receiving the vertical portions of two linearly connected rails. Each connector has a first side wall and a second side wall parallel with each other and integrally connected to each other for defining the slot. Multiple bolts respectively and sequentially extend through the first side wall of the connector and the vertical portion of the rail, and are screwed into the second side wall to stably fasten the multiple rails and the multiple connectors.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a rail assembly for slide-type garage door in accordance with the present invention;

FIG. 2 is an exploded perspective view of the rail assembly in FIG. 1;

FIG. 3 is a cross-sectional view of the rail assembly in FIG. 1 along line 3-3;

FIG. 4 is a cross-sectional view of a second embodiment of the connector of the rail assembly in FIG. 1;

FIG. 5 is a cross-sectional view of the rail assembly in FIG. 3 along line 5-5;

FIG. 6 is a schematic view of the rail assembly in accordance with the present invention;

FIG. 7 is a cross-sectional view of a third embodiment of the connector in accordance with the present invention; and

FIG. 8 is a perspective view of a conventional rail structure for slide-type garage door in accordance with the prior art;

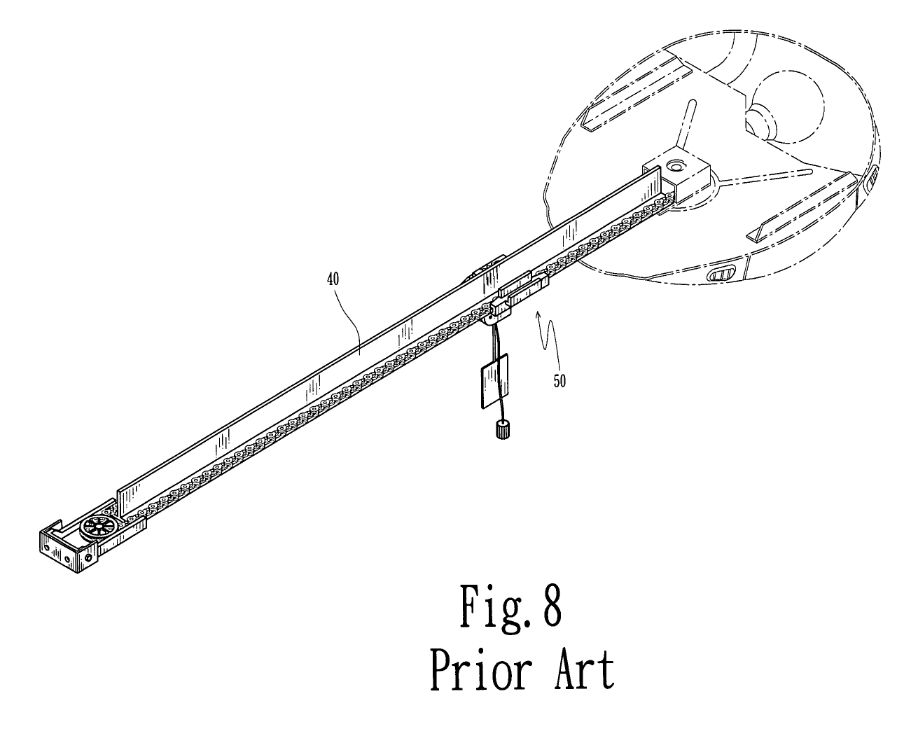

### DETAILED DESCRIPTION OF THE INVENTION

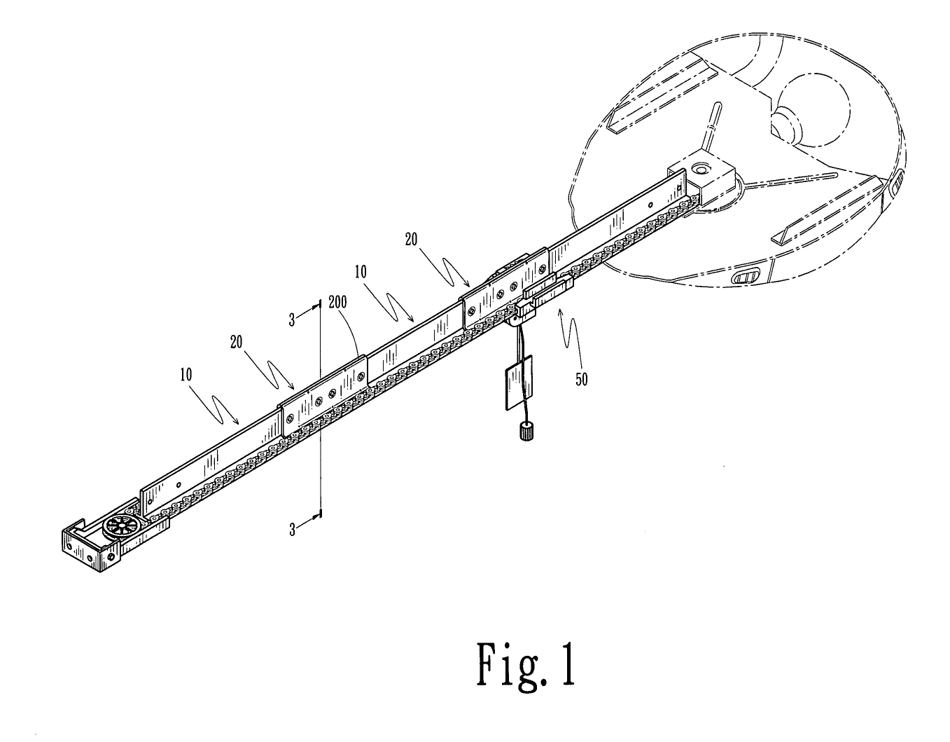

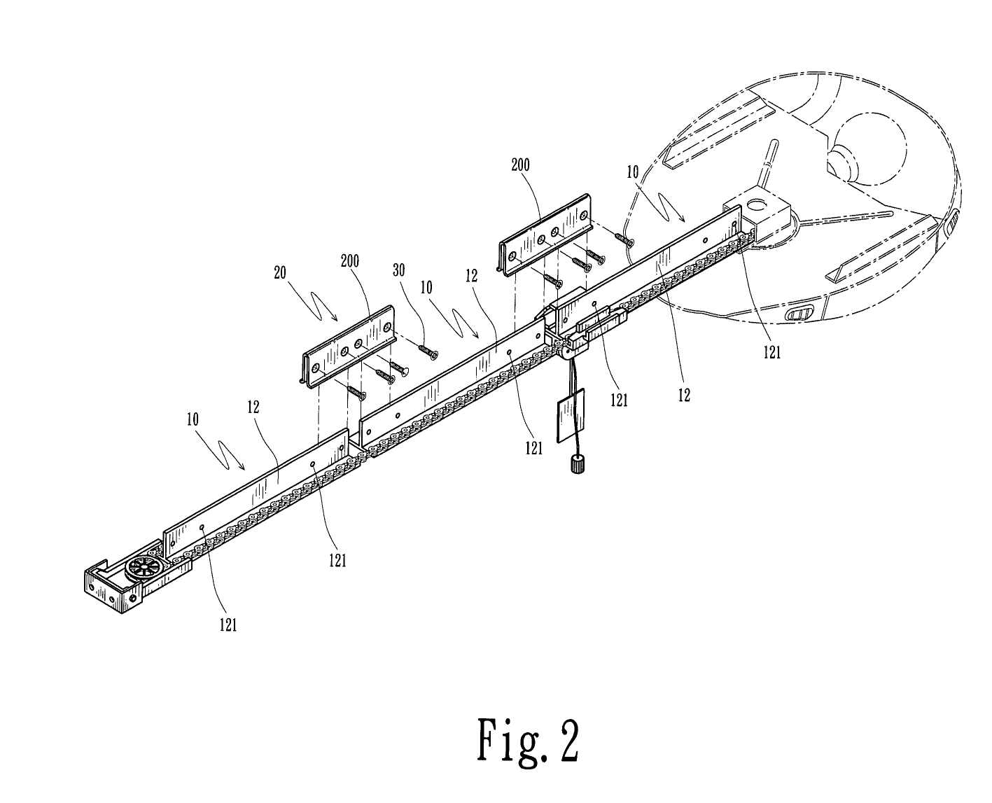

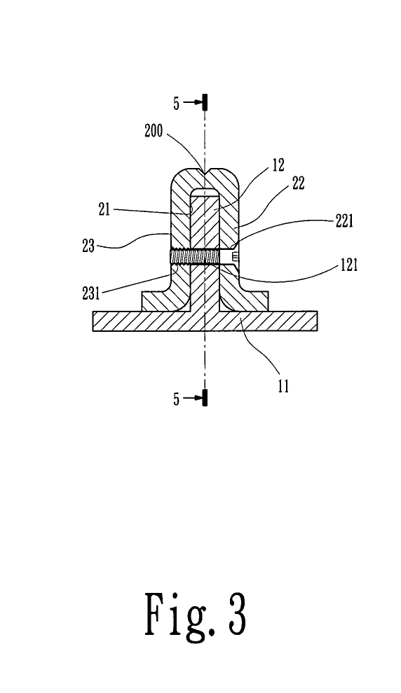

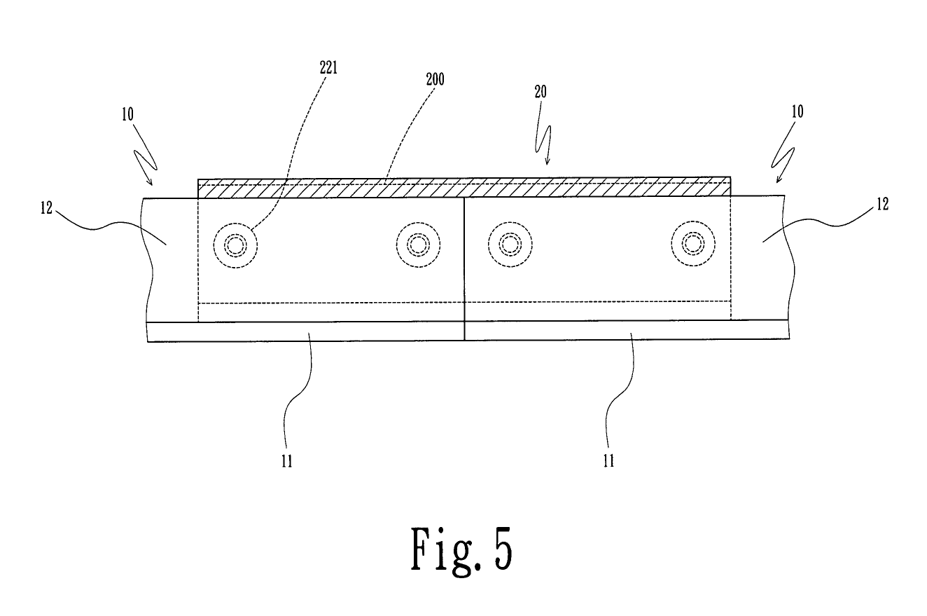

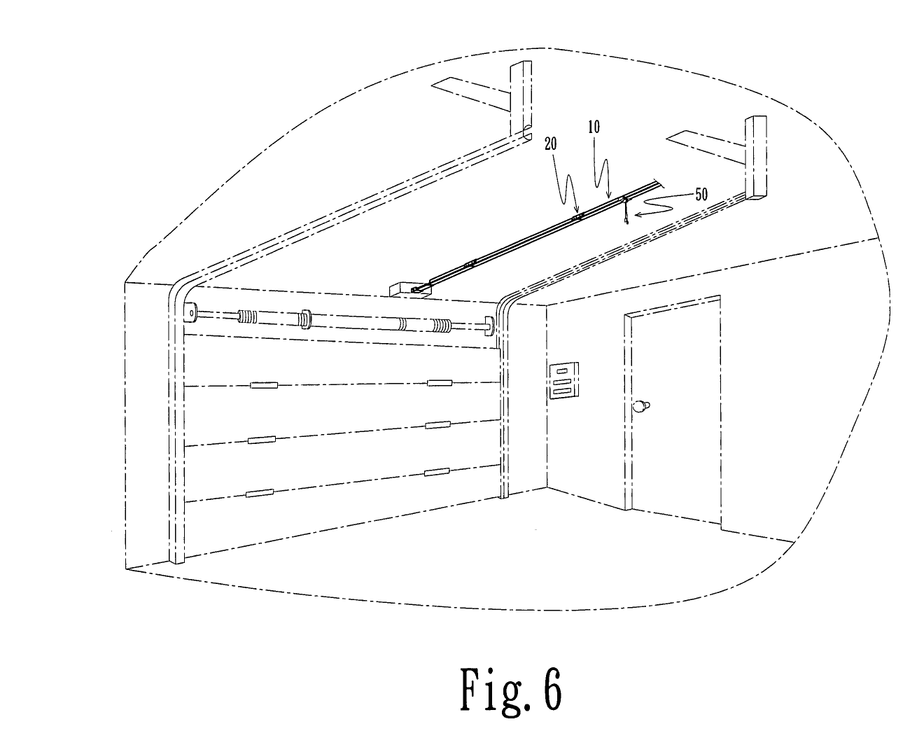

Referring to the drawings and initially to FIGS. 1-6, a rail assembly for slide-type garage door in accordance with the present invention comprises multiple rails (10), multiple connectors (20) for linearly connecting the multiple rails (10) and multiple bolts (30) for fastening the multiple rails (10) and the multiple connectors (20).

Each rail (10) has a horizontal portion (11) adapted to allow a slide (50) smoothly move thereon, and a vertical portion (12) centrally and perpendicularly extending from the horizontal portion (11) to form an inverted T-shape. The vertical portion (12) has two opposite ends each having at least one through holes (121) defined therein. In the preferred embodiment of the present invention, there are two through holes (121) defined in each of the two opposite ends of the vertical portion (12) of the rail (10) for providing stable connection between two rails (10).

The connector (20) has an i-shaped cross-section and a slot (21) defined therein for receiving the vertical portions (12) of two linearly connected rails (10).

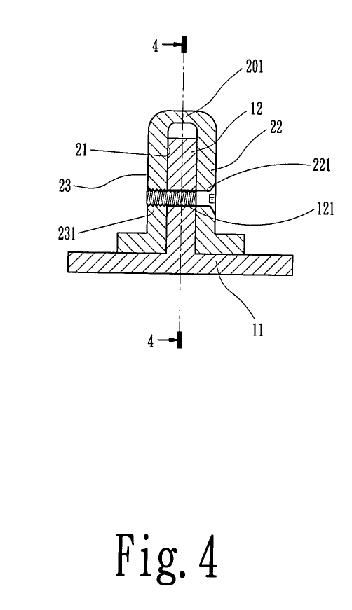

The connector (20) is integrally extracted by aluminum alloy and a groove (200) is longitudinally and centrally defined in the metal plate and located in a top of the connector (20) after forming the connector (20). The groove (200) provides a good elasticity to the processed connector (20) when the connector (20) is made of hard metal. The connector has a first side wall (22) and a second side wall (23) parallel with each other and integrally connected to each other for defining the slot (21). The connector (20) has at least two sunken holes (221) defined in the first side wall (22). The at least two sunken holes (221) in the connector (20) respectively align with the at least one through hole (121) of each of the two linearly connected rails (10). In the preferred embodiment of the present invention, there are four sunken holes (221) defined in the first side wall (22) of the connector (20). The connector (20) has at least two threaded holes (231) defined in the second side wall (23). Each threaded hole (231) aligns with a corresponding one of the at least two sunken holes (221) in the first side wall (22) of the connector (20). In the preferred embodiment of the present invention, there are four threaded holes (231) defined in the second side wall (22) of the connector (20). With reference to FIG. 4 that shows a second embodiment of the connector (20), the connector (20) is integrally formed by a metal plate such that a thin portion (201) is longitudinally formed on the top portion of the connector (20) after forming the connector (20).

When assembling the rail assembly in accordance with the present invention, the rails (10) are linearly connected to one another and connectors (20) are provided to receive the vertical portions (12) of two connected rails (10). In addition, each sunken hole (221) aligns with a corresponding one of the through holes (121) of the two connected rails (10). The bolt (30) sequentially extends through the sunken hole (221) in the first side wall (22) of the connector (20) and the through hole (121) in the vertical portion (12) of the rail (10), and is screwed into the threaded hole (231) in the second side wall (23) of the connector (20) to stably fasten the rails (10) and the connectors (20). The groove (200) and the thin portion (201) make the first side wall (22) and the second side wall (23) easily clamp the vertical portion (12) when screwing the bolts (30), that is, the operator can screw the bolts (30) more labor-saving.

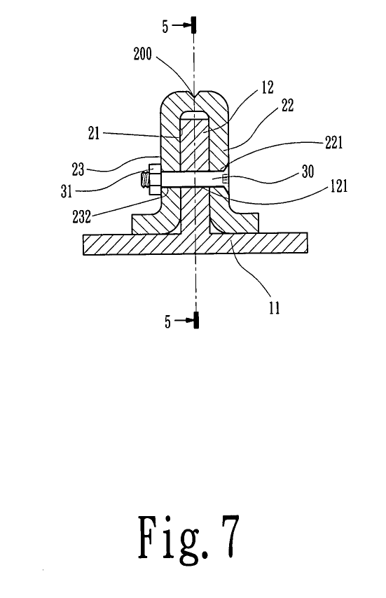

With reference to FIG. 7 that shows a third embodiment of the connector (20) of the present invention, the connector (20) has an Ω-shaped cross-section and a slot (21) defined therein for receiving the vertical portions (12) of two linearly connected rails (10).

The connector (20) is integrally extracted by aluminum alloy and a groove (200) is longitudinally and centrally defined in the metal plate and located in a top of the connector (20) after forming the connector (20). The groove (200) provides a good elasticity to the processed connector (20) when the connector (20) is made of hard metal. The connector has a first side wall (22) and a second side wall (23) parallel with each other and integrally connected to each other for defining the slot (21). The connector (20) has at least two sunken holes (221) defined in the first side wall (22). The at least two sunken holes (221) in the connector (20) respectively align with the at least one through hole (121) of each of the two linearly connected rails (10). In the preferred embodiment of the present invention, there are four sunken holes (221) defined in the first side wall (22) of the connector (20). The connector (20) has at least two through holes (232) defined in the second side wall (23). Each through hole (232) aligns with a corresponding one of the at least two sunken holes (221) in the first side wall (22) of the connector (20). In the preferred embodiment of the present invention, there are four through holes (232) defined in the second side wall (22) of the connector (20).

When assembling the rail assembly in accordance with the present invention, the rails (10) are linearly connected to one another and connectors (20) are provided to receive the vertical portions (12) of two connected rails (10). In addition, each sunken hole (221) aligns with a corresponding one of the through holes (121) of the two connected rails (10). The bolt (30) sequentially extends through the sunken hole (221) in the first side wall (22) of the connector (20), the through hole (121) in the vertical portion (12) of the rail (10) and the through hole (232) in the second side wall (23) of the connector (20), and a nut (31) is screwed onto the a free end of the bolt (30) to stably fasten the rails (10) and the connectors (20).

As described above, the rail assembly in accordance with the present invention has multiple advantages as follow:

1. The rail assembly of the present invention is easily assembled because only several bolts (30) can stably and linearly connect the rails (10) and connectors (20).

2. The conventional integral rail structure is divided into multiples sections such that the rail structure is easily packaged and transported.

3. The rail assembly of the present invention can be assembled to a suitable length to the purpose of the operator. It is convenient design.

Although the invention has been explained in relation to its preferred embodiment, it is to be understood that many other possible modifications and variations can be made without departing from the spirit and scope of the invention as hereinafter claimed.

What is claimed is:

1. A rail assembly for slide-type garage door, comprising:
multiple rails linearly connected to one another, each rail having a horizontal portion adapted to allow a slide smoothly move thereon, and a vertical portion centrally and perpendicularly extending from the horizontal portion to form an inverted T-shape, the vertical portion including two opposite ends each having at least one through holes defined therein;
multiple connectors partially receiving the vertical portion of the multiple rails, each connector having an Ω-shaped cross-section and a slot defined therein for receiving the vertical portions of two linearly connected rails, each connector having a first side wall and a second side wall parallel with each other and integrally connected to each other for defining the slot, each connector having at least two sunken holes defined in the first side wall, the at least two sunken holes respectively align with the at least one through hole of each of the two linearly connected rails, the connector having at least two threaded holes defined in the second side wall, each threaded hole aligning with a corresponding one of the at least two sunken holes in the first side wall of the connector; and
multiple bolts screwed onto a corresponding one of the multiple connectors, each bolt sequentially extending through the sunken hole in the first side wall of the connector and the through hole in the vertical portion of the rail, and screwed into the threaded hole in the second side wall of the connector to stably fasten the multiple rails and the multiple connectors.

2. The rail assembly as claimed in claim 1, wherein the connector is extracted formed by aluminum alloy and a groove is longitudinally and centrally defined in the metal plate and located in a top of the connector after forming the connector, thereby, the groove makes the first side wall and the second side wall easily clamp the vertical portion when screwing the bolts.

3. The rail assembly as claimed in claim 1, wherein the connector is integrally formed by a metal plate such that a thin portion is longitudinally formed on the top portion of the connector after forming the connector, the groove makes the first side wall and the second side wall easily clamp the vertical portion when screwing the bolts.

4. A rail assembly for slide-type garage door, comprising:
multiple rails linearly connected to one another, each rail having a horizontal portion adapted to allow a slide smoothly move thereon, and a vertical portion centrally and perpendicularly extending from the horizontal portion to form an inverted T-shape, the vertical portion including two opposite ends each having at least one through holes defined therein;
multiple connectors partially receiving the vertical portion of the multiple rails, each connector having an Ω-shaped cross-section and a slot defined therein for receiving the vertical portions of two linearly connected rails, each connector having a first side wall and a second side wall parallel with each other and integrally connected to each other for defining the slot, each connector having at least two sunken holes defined in the first side wall, the at least two sunken holes respectively align with the at least one through hole of each of the two linearly connected rails, the connector having at least two through holes defined in the second side wall, each through hole aligning with a corresponding one of the at least two sunken holes in the first side wall of the connector; and
multiple bolts screwed onto a corresponding one of the multiple connectors, each bolt sequentially extending through the sunken hole in the first side wall of the connector, the through hole in the vertical portion of the rail and the through hole in the second side wall of the connector, a nut screwed onto a free end of the bolt to stably fasten the multiple rails and the multiple connectors.

5. The rail assembly as claimed in claim 4, wherein the connector is extracted formed by aluminum alloy and a groove is longitudinally and centrally defined in the metal plate and located in a top of the connector after forming the connector, thereby, the groove makes the first side wall and the second side wall easily clamp the vertical portion when screwing the bolts.

6. The rail assembly as claimed in claim 4, wherein the connector is integrally formed by a metal plate such that a thin portion is longitudinally formed on the top portion of the connector after forming the connector, the groove makes the first side wall and the second side wall easily clamp the vertical portion when screwing the bolts.
